(19) United States
(12) Patent Application Publication
(10) Pub. No.: US 2024/0374948 A1
(43) Pub. Date: Nov. 14, 2024

(54) METHOD FOR TREATING A PRODUCT CONTAINING ASBESTOS

(71) Applicants: Centre National de la Recherche Scientifique, PARIS (FR); Université de Strasbourg, STRASBOURG (FR)

(72) Inventors: Sébastien DAVID, GERSTHEIM (FR); Valérie GEOFFROY, GRASSENDORF (FR)

(21) Appl. No.: 18/690,250

(22) PCT Filed: Sep. 9, 2022
(86) PCT No.: PCT/FR2022/051706

§ 371 Date: Mar. 7, 2024

(30) Foreign Application Priority Data
Sep. 9, 2021 (FR) FR2109454

(51) Int. Cl. A62D 3/02; A62D 101/41

(52) U.S. Cl. CPC A62D 3/02; A62D 2101/41

(57) ABSTRACT

The present invention relates to a process for treating an asbestos-containing product characterized in that it comprises grinding the asbestos-containing product, which is preferably asbestos waste, and incubating the said ground product with whey seeded with lactic acid bacteria. The process may further comprise a step of real-time determination of the concentration of iron and/or magnesium released by the ground asbestos-containing product in the whey and/or a step of contacting an altered waste still containing iron and/or magnesium after incubation with whey seeded with lactic acid bacteria, with a siderophore-producing bacterium.

### CROSS-REFERENCE TO RELATED APPLICATIONS

The present application is a filing under 35 U.S.C. 371 as the National Stage of International Application No. PCT/FR2022/051706, filed Sep. 9, 2022, entitled “METHOD FOR TREATING A PRODUCT CONTAINING ASBESTOS,” which claims priority to French Application No. 2109454 filed with the French Patent Office on Sep. 9, 2021, both of which are incorporated herein by reference in their entirety for all purposes.

### INTRODUCTION

The present invention falls within the field of biological methods for treating products containing asbestos, and in particular asbestos waste.

Asbestos refers to fibrous minerals of the phylo-magnesium silicate type which were commonly used for their numerous properties, in particular insulating properties, and their chemical and mechanical resistances. Their use has been prohibited in France since 1997 because of the harmful consequences on human health. Currently, asbestos removal at numerous sites generates waste that constitutes sizable masses to which society must address. One of the major concerns is to find an ecological, economical, rapid, and industrial-scale solution to eliminate or recover the various types of asbestos waste. Chrysotile (Mg₆Si₄O₁₀ (OH)₈), the only asbestiform mineral in the serpentine subgroup, accounts for 95% of industrial asbestos use. The main asbestos-based products come mainly from the building and public works sector, and include asbestos cement, which accounts for around 80% of the world's asbestos production, and bulk raw asbestos used in flocking processes.

To date, there is no satisfactory treatment for asbestos. The most widely used asbestos removal method in France today is landfill disposal in specialized centers. Although it is economical, it requires large storage areas to hold waste. In addition, it does not make it possible to treat the dangerousness of the asbestos (Damien, 2016). Plasma fusion vitrification is also used to treat asbestos-containing products (Spasiano and Pirozzi, 2017). However, although effective, this method of asbestos removal is extremely costly, not least because of its energy-consuming nature.

Chemical or thermochemical treatments are also envisaged, some of which generate a valuable, high-value-added recovery product. Nevertheless, there are still some limiting points. In particular, chemical treatments are based on acid attack on chrysotile and require the use of strong acids (e.g. hydrochloric, nitric, sulfuric or hydrofluoric acids), which poses problems linked to the hazardous nature of these acids.

In addition to the above-mentioned treatment methods, biological treatments are also envisaged, in particular using by-products and waste from the agri-food industry. For example, application WO 2015/166359 describes an asbestos treatment process comprising preparing an acid solution by subjecting food industry waste to mixed fungal and bacterial (Saccharomyces cerevisiae and Acinetobacter acetii) proliferation and/or fermentation, and treating an asbestos-containing material with the acid solution/suspension obtained from the mixed fermentation at a temperature of 120 to 170° C. and a pressure of 2 to 10 bar. A method using whey from the dairy industry, for example, has been developed to treat asbestos cement waste. In fact, whey is an acidic waste product, composed in particular of lactic acid, which releases asbestos fibers from the waste by dissolving the cementitious matrix. The fibers are then treated by hydrothermal attack making it possible to obtain an inert waste (EP2428254B1). Although these biological methods have the advantage of being more environmentally-friendly and less hazardous than the treatments mentioned above, their effectiveness needs to be improved in terms of both asbestos removal and cost. In particular, the process described in EP2428254B1 is based on heavy extraction of iron and magnesium resulting in the alteration of the asbestos. This extraction is linked to the acidic pH of the whey, which increases progressively during the reaction as the magnesium oxide dissolves, rapidly limiting the efficiency of the process. It is therefore necessary to add a hydrothermal treatment step to achieve more effective asbestos alteration.

Other authors describe the use of microorganisms whose metabolism would make it possible to alter asbestos. For example, Stanik et al (2006) describe the use of Lactobacillus casei and Lactobacillus plantarum in the destruction of the chrysotile of the asbestos. However, using only the metabolites (mainly acids) produced by the activity of these bacteria fails to alter asbestos very effectively (only 7.5% Mg and 1.3% Fe are extracted after 10 days of culture).

From the above, it appears that biological means of altering asbestos in products containing it are the most promising from an ecological point of view, and particularly in terms of cost, as they enable waste from the agri-food industry to be recovered. However, the effectiveness of these methods must be improved further so that the asbestos contained in the products containing it, in particular the waste, is almost entirely or even completely altered by the biological process.

There is therefore still a need for a method for treating asbestos waste that is environmentally-friendly and effective.

While the prior art recommends using hydrothermal treatment to improve asbestos alteration in whey, but not using microorganisms because of the low asbestos alteration rate (paragraph of EP2428254), the present inventors have surprisingly found that seeding (or inoculating) whey with lactic acid bacteria, and in particular, with lactic acid bacteria selected from the group comprising Lactobacillus plantarum, Lactobacillus pentosus, Lactobacillus plantarum subsp argentoratensis, Lactococcus lactis, Lactobacillus sakei subsp sakei 484, Lactobacillus paraplantarum, Lactobacillus salivarius, Lactobacillus casei, Lactobacillus fermentum, Pediococcus pentosaceus, Lactobacillus brevis, Pediococcus parvulus, Lactobacillus paracasei, Lactobacillus rhamnosus, Lactobacillus casei and L. paracasei subsp paracasei, helps maintain the acidic pH of whey required for asbestos alteration (cf. table 1 in the experimental part of this application) thanks to the lactic acid fermentation induced by these bacteria during alteration. This alteration of asbestos in whey seeded with lactic acid bacteria is confirmed by the high extraction of iron and magnesium (see FIGS. 7A-7B, 13 and 14 of this application).

The present inventors also surprisingly discovered that the degree of deterioration of asbestos is increased by a prior step of grinding the product comprising asbestos. The authors have shown that the extraction of iron and/or magnesium is greater in ground asbestos cement waste than in unground flock waste (see FIGS. 7A-7B of this application).

The present application thus relates to a method for treating a product containing asbestos, said method comprising the following steps:
a) grinding the asbestos-containing product,
b) incubating the product ground in step a) with whey inoculated with lactic acid bacteria.

The term “asbestos” as is understood herein means the varieties of hydrated, magnesium or calcic, silicates, formed naturally during the metamorphism of the rocks, which can be transformed into mineral fibers. There are various asbestos categories corresponding to several mineral varieties:

serpentines, which are hydrated magnesium phyllosilicates with a lamellar structure. The most common fibrous form of these is “chrysotile” or “white asbestos”;-amphiboles, double-chain silicates that can comprise five distinct fibrous varieties: anthophyllites, actinolites, tremolites, amosites (known as “brown asbestos”) and crocidolites (known as “blue asbestos”), each with a different chemical composition. According to one embodiment of the method, the product comprising asbestos is a waste containing asbestos. Several types of asbestos waste are distinguished:
free asbestos waste, in friable form, from flocking or insulating waste,
bonded asbestos waste in non-friable form, also known as “asbestos cement” or “fibrocement”.

Generally speaking, flocking or insulating waste is preferably chrysotile with the formula

[Mg₃(Si₂O₅)(OH)₄].

Chrysotile does not contain internalized iron in its theoretical chemical composition, although iron may be present as a result of magnesium and silicon substitutions on the sheets. Furthermore, chrysotile also contains magnesium in its crystalline structure, which can be extracted to alter this asbestos waste.

Generally speaking, asbestos fiber cement waste is amphibole asbestos waste, preferably amosite with the formula [(Fe²⁺Mg)₇Si₈O₂₂ (OH)₂] or crocidolite with the formula [Na₂Fe²⁺₃ (Fe²⁺Mg)₃Si₈O₂₂ (OH)₂]. These two types of amphitiles contain both magnesium and iron in their crystalline structure.

Such asbestos waste can be of “native” or “heterogeneous” composition.

The term “native” asbestos waste is understood here to mean “homogeneous” waste containing pure asbestos, i.e. the pure mineral not comprising additional material in its structure. “Homogeneous” asbestos waste contains crystalline natural asbestos fibers. The term “heterogeneous” asbestos waste is understood here to mean a waste containing asbestos and other compounds, such as for example metals, gypsum, carbonates, in particular calcium carbonates present in particular in cement. In flocking materials, which are particularly friable and dangerous, asbestos is mixed with gypsum.

According to one particular embodiment, the asbestos-containing product is selected from the group comprising a flock or insulation waste or a fiber cement waste.

According to another particular embodiment, the asbestos-containing product can be a homogeneous asbestos waste or a heterogeneous asbestos waste.

More particularly, the asbestos waste may be flock waste, vinyl tiles, fiber cement predominantly containing chrysotile and possibly containing amphibos.

According to a preferred embodiment, the asbestos-containing product treated by the method described herein is an asbestos-containing waste preferably selected from the group consisting of flock or insulation waste or fiber cement, having a homogeneous or heterogeneous composition.

The method described herein makes it possible to transform the asbestos waste, in particular by reducing the concentration of magnesium and/or iron until an altered waste is obtained consisting of a solid phase and a liquid phase. These two phases can be separated by any techniques known to the person skilled in the art, in particular for the recovery of each of them.

The solid phase of the altered waste, called “solid altered waste”, will subsequently be able to serve as a base material for the manufacture of zeolite. In the same way, said liquid phase of the altered waste, called “liquid altered waste”, can be exploited in particular by recovery of iron and/or magnesium.

Here, the term “solid altered waste” means an asbestos waste whose crystalline structure is modified and destructured since it is depleted or free of iron and/or magnesium following total or partial extraction by bringing the ground product comprising asbestos, preferably the asbestos waste, with whey inoculated with lactic acid bacteria.

Here, the term “liquid altered waste” means the liquid phase comprising the whey obtained after incubation step b), which contains the iron and/or magnesium extracted from the asbestos waste.

In other words, the altered waste obtained will contain a lower quantity of asbestos fiber, or even zero, relative to the amount initially present in the asbestos waste before the implementation of the present method.

As mentioned above, the asbestos-containing product, and preferably the asbestos-containing waste, is altered by grinding it and incubating the ground product with whey inoculated with lactic acid bacteria.

The term “grinding” as used here refers to a mechanical treatment capable of transmitting mechanical energy to the ground asbestos-containing product. The grinding in step a) of the method could be carried out in any type of mill having the dimensions and the mechanical characteristics making it possible to completely grind the product containing asbestos by reducing the length of the fibers increasing the specific surface area. In particular, grinding is performed in a planetary ball mill (FRITSCH PULVERISETTE 6) or in a Retsch PM100 planetary mill. Preferably, the mill is a Retsch PM100 planetary mill.

Preferably, the grinding in step a) of the method is carried out in a planetary mill which grinds the asbestos-containing product for 10 minutes at 500 rpm. A person skilled in the art is capable of adapting the time and the speed of grinding depending on the type of asbestos-containing product being ground, its size and its other physical characteristics. When a product containing asbestos is ground, in particular when this product is a fiber cement, the grinding preferably takes place in a liquid medium in order to prevent the dissemination of the asbestos fibers and dust. Any liquid medium that is suitable for this use can be used. For example, this liquid medium may be water or a liquid waste product from the food industry that enables lactic acid bacteria to grow, such as sauerkraut juice or whey. Preferably, the liquid medium is whey.

Thus, according to a particular embodiment, grinding in step a) is carried out in a liquid medium, preferably in whey.

Here, “whey” means the liquid residue left over from the coagulation of milk. Whey is a greenish-yellow liquid made up of around 94% water, sugar (lactose), protein and very little fat. At the start of the cheese-making process, milk is coagulated by adding rennet, the acidifying action of lactic acid bacteria, or chemical acidification. This results in an aggregation of milk casein micelles, which gives a gel (or curd or coagulum). An aqueous liquid, called “whey,” is separated from the curd. This curdling stage consists of separating total milk proteins into two protein phases: the aqueous phase containing serum or water-soluble milk proteins (β-lactoglobulin, α-lactalbumin, serum albumin, lactoferrin, caseinomacropeptide) and the solid phase in which hydrophobic casein has been retained (α-casein, β-casein, para-κ-casein). The whey used in the process described here is an acid whey with a pH generally between 3.5 and 4.5. In particular, the inventors used whey supplied by the company Alsace Lait.

The term “lactic acid bacteria” as used herein refers to single-celled prokaryotic, heterotrophic, and chemo-organotrophic microorganisms. Lactic acid bacteria tolerate acidic pH and possess strict or aerotolerant anaerobic metabolism. Lactic acid bacteria as understood herein have a fermentative metabolism. They especially produce lactic acid as a main product of metabolism by fermenting sugars (glucose, fructose, mannose, galactose, sucrose and lactose) in homofermentative bacteria, in addition to ethanol and CO₂ in heterofermentative bacteria.

By “lactic acid bacteria” we particularly mean bacteria from the Aerococcaceae, Carnobacteriaceae, Lactobacilluseae, Streptoccaceae, Enterococcaceae, Leuconostocaceae and Bifidobacteriaceae families. Preferably, we mainly use lactic acid bacteria belonging to the genera Lactobacillus, Lactococcus, Streptococcus and Bifidobacterium, which are indigenous lactic acid bacteria found in the human digestive tract. More preferably, the lactic acid bacteria used in the present method belong to the genera Lactobacillus, Pediococcus, or Lactococcus. Even more preferably, these bacteria belong to the genera Lactobacillus or Pediococcus. Even more preferably, the lactic acid bacteria used in the present method are Lactobacillus casei, Lactobacillus acidophilus, Lactobacillus delbrueckii subsp. bulgaricus, Lactobacillus rhamnosus, Lactobacillus helveticus, Lactobacillus paraplantarum, Lactobacillus pentosus, Lactobacillus plantarum. Lactobacillus plantarum subsp argentoratensis, Lactococcus lactis, Lactobacillus sakei subsp sakei 484, Lactobacillus salivarius, Lactobacillus fermentum, Pediococcus pentosaceus, Lactobacillus brevis, Lactococcus lactis, Pediococcus parvulus, Lactobacillus paracasei, Lactobacillus casei and L. paracasei subsp paracasei.

Thus, according to a preferred embodiment, the lactic acid bacteria used in the present method are bacteria with fermentative metabolism, in particular lactobacilli, lactococci or Pediococcus, preferably selected from Lactobacillus brevis, Lactococcus lactis, Pediococcus parvulus, Lactobacillus paracasei, Lactobacillus rhamnosus, Lactobacillus paracasei subsp paracasei, Lactobacillus pentosus, Lactobacillus casei and Lactobacillus plantarum.

According to another embodiment, the method described herein may comprise, prior to step b), a step of seeding (or inoculating) the whey with lactic acid bacteria.

This seeding (inoculation) step can be carried out before, in parallel with or after step a) of grinding the asbestos-containing product.

The seeding (or inoculation) step is carried out by culturing the lactic acid bacteria in a culture medium suitable for bacterial growth, in particular a culture medium which promotes the growth of lactic acid bacteria. A person skilled in the art will be able to select any suitable medium for the growth of lactic acid bacteria. Preferably, the culture medium is selected from a MRS medium (Man, Rogosa, Sharpe agar), a rich LB medium (Luria Broth), a minimal medium (MOPS) supplemented or not with glucose, or a whey medium. More preferably, the culture medium is an MRS medium (Man, Rogosa, Sharpe agar) or a medium consisting of whey.

The culturing of the lactic acid bacteria in the culture medium is carried out for a duration which can range from 20 to 30 hours, preferably from 22 to 28 hours, more preferably from 24 to 26 hours and even more preferably, this duration is 24 hours.

The culture temperature of the lactic acid bacteria in the culture medium is a temperature favorable to bacterial growth. Preferably, this temperature is between 20° C. and 40° C., preferably between 25° C. and 37° C., more preferably between 30° C. and 35° C. and even more preferably, the culturing temperature is 30° C.

According to a preferred method, lactic acid bacteria are cultured in an MRS medium or a whey medium for 24 to 26 hours, preferably for 24 hours, at a temperature of between 30° C. and 35° C., preferably at 30° C.

During the phase of culturing the lactic acid bacteria, the culture medium may or may not be subjected to agitation. Preferably, the culture medium is not subjected to agitation so that bacterial growth takes place in the absence of agitation.

At the end of the culture period, the bacterial culture is centrifuged for a period ranging from 3 to 10 minutes, preferably from 5 to 7 minutes and more preferably, for a period of 5 minutes.

The centrifuging speed can be between 1000 and 20,000 g, preferably between 5000 and 10,000 g and more preferably between 8000 and 10,000 g.

According to a particularly preferred embodiment, the lactic acid bacteria are cultivated in an MRS culture medium or a medium consisting of whey for 24 hours at 30° C. and the culture is then centrifuged for 5 minutes.

After centrifugation, the pellet is washed, preferably in whey, and resuspended in whey. The washing, preferably washing in whey, can be carried out at least once, preferably 2 to 10 times, more preferably 2 to 8 times and even more preferably 2 to 4 times.

The concentration of lactic acid bacteria in whey seeded with these bacteria was then adjusted by diluting the bacterial culture in whey, and the optical density (OD) of the bacteria at a wavelength of 600 nm (OD600) was measured.

The term “optical density at 600 nm (OD600)” as used herein refers to the measurement of bacterial growth by optical density at 600 nm. This measurement is based on the absorbance detection mode and substantially determines which part of the light passes through a sample of bacteria. The particles in solution scatter the light and the more particles (bacteria) are in a suspension, the more they scatter the light. Consequently, a replicating population of bacteria increases light scattering and the absorbance values measured. At the same time, this means that the absorbance mode is used only to determine the extent of the dispersion of the light instead of measuring the physical absorbance of the light energy by absorbing molecules. Thus, the dispersion of the light and the value OD600 can be directly linked to the bacteria count. According to one embodiment of the method described herein, the optical density at 600 nm (OD600) of the lactic acid bacteria in the whey at the end of the seeding (inoculation) stage is between 0.5 and 2, preferably between 1 and 1.5 and most preferably 1.

After the whey has been inoculated with lactic acid bacteria, the inoculated whey is brought into contact with the asbestos-containing product. Preferably, contact is made with whey to obtain a mixture containing the whey inoculated with lactic acid bacteria, the whey and the ground product containing asbestos. In this mixture, the ratio of whey inoculated with lactic acid bacteria to whey can be between 1 and 1000, preferably between 2 and 1000, and the quantity of asbestos waste can be between 0.1% and 10% of the total quantity of said mixture, preferably between 1% and 8% of the total quantity of said mixture. In a particular embodiment, one part of inoculated whey is mixed with nine parts of whey and 1% ground asbestos-containing product.

According to a preferred embodiment, the concentration of lactic acid bacteria in whey seeded with lactic acid bacteria containing the ground asbestos-containing product prior to incubation in step b) (i.e., at a time TO as shown in FIG. 1) is between 1×10⁵×10⁹ CFU/ml, preferably between 1×10⁶×10⁸ CFU/ml and more preferably, is 1×10⁸ CFU/ml. Thus, the optical density of the bacteria before step b) of incubation at OD600 is between 0.0001 and 1, preferably between 0.001 and 0.5, more preferably between 0.01 and 0.3, even more preferably between 0.05 and 0.1 and is more preferably 0.1.

The whey inoculated with lactic acid bacteria and comprising the ground asbestos-containing product is then incubated in step b) of the method described herein.

According to a particular embodiment, the incubation in step b) is carried out for a period of 24 to 96 hours, preferably 30 to 80 hours and more preferably 72 hours. Preferably, this incubation is carried out at a temperature between 20° C. and 40° C., preferably between 25° C. and 37° C., more preferably between 30° C. and 35° C. and even more preferably, the incubation temperature is 30° C.

According to a preferred embodiment, the incubation step b) is carried out for a period of 30 to 80 hours at a temperature of between 30° C. and 35° C.; preferably, the incubation step b) is carried out for a period of 72 hours at 30° C.

According to one embodiment, the incubation in step b) is carried out with stirring at a speed of between 10 and 600 rpm and preferably between 100 and 400 rpm.

The incubation step b) can be carried out in a bioreactor, preferably a Global Process Concept, Laval Lab or AD Biotec bioreactor.

As mentioned above, the present inventors have demonstrated that the products of lactic acid bacteria metabolism can reduce and stabilize the pH of whey, which is increased by the dissolution of magnesium oxides during asbestos alteration, thereby reducing alteration. Consequently, maintaining a highly acidic pH during the incubation step b) makes it possible to improve the efficiency of asbestos alteration in the product containing it.

Thus, according to a particular embodiment, the pH of the whey containing the lactic acid bacteria and the ground asbestos-containing product in step b) is between 2.5 and 4.5, preferably between 3 and 4, more particularly between 3.7 and 4, and even more preferably, the pH is 3.7.

At the end of incubation step b), which is notably a bacterial growth step, the concentration of bacteria is at least 1×10⁹ CFU/ml.

The incubation step b) can be repeated in order to improve the effectiveness of the asbestos alteration. Preferably, step b) is repeated at least once, at least twice, at least three times, at least four times, at least five times, at least six times, at least seven times, at least eight times, at least nine times, at least ten times, more preferably, step b) of incubation is repeated between 2 and 10 times, and more preferably between 4 to 6 times. If the incubation step is to be repeated at least once, it is preferable to dilute the whey obtained at the end of the first incubation step prior to the new incubation step. In fact, this whey includes lactic acid bacteria in a higher concentration than that in the whey before incubation, iron and magnesium dissolved as a result of asbestos alteration, and may also include traces of the product containing asbestos that has not yet been altered. In order to avoid saturation of the whey due to the increased concentration of bacteria during incubation step b) and the concentration of iron and magnesium dissolved in the whey, it is necessary to dilute the whey obtained at the end of incubation step b) before subjecting it to a possible new incubation step. This dilution is necessary to prevent saturation of the whey seeded with lactic acid bacteria at the end of incubation step b), and a reduction in its ability to alter the asbestos that has not yet been altered. The main aim of this dilution is to reduce the concentration of lactic acid bacteria and thus avoid a phase of bacterial lysis, which would lead to a reduction in the products synthesized during bacterial metabolism, in particular organic acids, and hence an increase in whey pH.

The whey obtained at the end of incubation step b) is diluted before the next incubation step by gentle centrifugation for approximately 3 to 10 minutes, preferably 5 minutes. This centrifugation is intended to separate the asbestos from lactic acid bacteria and thus release them for a new growth cycle during the new incubation step. After centrifugation, part of the supernatant is recovered and whey is added to the remaining fraction. The step of separating bacteria from asbestos by centrifugation can be repeated at least once more, preferably between 1 and 4 times under the same centrifugation conditions. Each time, part of the supernatant is recovered and whey is added to the remaining fraction. After this (these) centrifugation(s), the remaining fraction (containing whey, lactic acid bacteria and unaltered asbestos residues) and the last added whey, is subjected to a further centrifugation step lasting between 20 and 40 minutes, more preferably between 25 and 35 minutes and even more preferably 30 minutes. At the end of this new centrifugation stage, the supernatant is completely removed and whey is added to the pellet to obtain a mixture of whey seeded with lactic acid bacteria and unaltered asbestos residues (FIG. 2). The concentration of lactic acid bacteria in this mixture is the same as that described above for bacteria in whey seeded with lactic acid bacteria comprising the ground asbestos-containing product before being subjected to the first incubation in step b).

Thus, according to one embodiment, step b) of the method is repeated at least once, preferably between 2 and 10 times, and more preferably between 4 and 6 times, said method optionally further comprising one or more steps of diluting the whey containing lactic acid bacteria and the ground asbestos-containing product.

According to a particular embodiment, the method for treating the product comprising asbestos results in the reduction of the iron and/or magnesium contained in the asbestos. This reduction consists of extracting at least part of the iron and/or magnesium present on the surface of the asbestos product or internalized into its crystalline structure. Advantageously, the entirety of the iron and/or magnesium is extracted from said asbestos product.

According to another embodiment of the method, the amount of iron and/or magnesium in the asbestos-containing product can be assayed prior to the method, by various methods (ICP-AES, atomic absorption spectrometry). This assay gives the “initial quantity” of the iron and/or magnesium present in the asbestos product before the implementation of the method described herein.

After completion of step b) of incubating the whey seeded with lactic acid bacteria and the ground asbestos-containing product, the amount of iron and/or magnesium possibly remaining in the asbestos-containing product can be determined by determining the amount of iron and/or magnesium in the whey. This quantity is generally measured in the supernatant obtained after centrifuging the whey at the end of incubation step b).

The quantities of iron and/or magnesium can be measured after a single incubation step, after each incubation step if the incubation step b) is repeated more than once, or after two or more successive incubation steps.

Preferably, the concentration (the amount) of iron and/or magnesium is measured in real time. As understood herein, “measure in real time” means that several measurements of the same sample are carried out for a predetermined period of time (measurement period) in order to provide a record of the evolution of the concentration as a function of time with a temporal resolution. This measurement period may last from 20 min to 180 min, preferably from 20 min to 60 min and more preferably from 15 min to 40 min. As a function of the duration of the measurement period, each sample can be measured 20 to 200 times, more preferably 20 to 75 times and more preferably 15 to 50 times.

Thus, according to a particular embodiment, the method can further comprise a step c) of real-time assaying of the concentration of iron and/or magnesium released by the asbestos-containing product in the whey from step b).

The difference in the concentration of iron and/or magnesium measured before the implementation of the method and after incubation step b) will reflect the amount of iron and/or magnesium reduced in the asbestos-containing product during the implementation of the method.

According to a particularly preferred embodiment, the method described in this application is a method for treating an asbestos-containing product comprising the following steps:
a) grinding the asbestos-containing product,
b) incubating the product ground in step a) with whey inoculated with lactic acid bacteria, in which method:
the grinding in step a) is carried out in a liquid medium, preferably in whey;
prior to step b), the whey is inoculated with lactic acid bacteria;
the concentration of lactic acid bacteria in the whey containing the ground asbestos-containing product before incubation in step b) is between 1×10⁵ and 1×10⁹ CFU/ml, preferably between 1×10⁶ and 1×10⁸ CFU/ml and more preferably, is 1×10⁸ CFU/ml;
the pH of the whey containing the lactic acid bacteria and the ground asbestos-containing product in step b) is between 2.5 and 4.5, preferably between 3 and 4 and even more preferably, the pH is 3.7;
the incubation time in step b) is from 24 to 96 hours, preferably from 30 to 80 hours and more preferably 72 hours;
step b) of the method is repeated at least once, preferably between 2 and 10 times, and more preferably between 4 and 6 times, said method optionally further comprising one or more steps of diluting the whey containing lactic acid bacteria and the ground asbestos-containing product;
a step c) of real-time assaying of the concentration of iron and/or magnesium released by the ground asbestos-containing product in the whey of step b) is carried out;
the ground asbestos-containing product is an asbestos-containing waste preferably selected from the group consisting of flock or insulation waste or fiber cement, having a homogeneous or heterogeneous composition, and
lactic acid bacteria are bacteria with fermentative metabolism, in particular lactobacilli, Pediococcus or lactococci, preferably selected from the group comprising Lactobacillus brevis, Lactococcus lactis, Pediococcus parvulus, Lactobacillus paracasei, Lactobacillus rhamnosus, Lactobacillus paracasei subsp paracasei, Lactobacillus pentosus, Lactobacillus casei and Lactobacillus plantarum, most preferably Lactobacillus plantarum.

As mentioned above, the method described herein makes it possible to transform the asbestos waste, in particular by reducing the concentration of magnesium and/or iron contained in the asbestos. In order to improve the efficiency of this method, an additional step of reducing the concentration of the magnesium and/or iron contained in the asbestos may be added. Such a step is particularly advantageous in that it makes it possible to substantially increase the extraction of the iron and/or magnesium contained in the asbestos.

This additional step is preferably a bacterial biological treatment step, and even more preferably, a treatment step with siderophore-producing bacteria, and even more preferably, a treatment step with bacteria of the Pseudomonas genus.

Thus, according to one embodiment, the method of the present invention comprises a step d) of bringing an altered waste still containing iron and/or magnesium after incubation with whey seeded with lactic acid bacteria, into contact with a siderophore-producing bacterium.

Preferably, the siderophore-producing bacterium is a bacterium from the group of fluorescent Pseudomonas capable of producing siderophores, preferably pyoverdine.

According to an embodiment, the siderophore-producing fluorescent Pseudomonas are predominantly non-pathogenic, in particular they are selected from: Pseudomonas lini, Pseudomonas putida, Pseudomonas monteilii, Pseudomonas syringae, Pseudomonas 20 aeruginosa PAO1, Pseudomonas fluorescens, Pseudomonas mosselii. Preferably, the extraction of iron and/or magnesium is carried out by bringing said asbestos waste in contact with a strain of Pseudomonas putida. This strain is a strain of Pseudomonas putida, wild-type (strain KT2440 described in Nelson, K. E., 2002) or a pyoverdine-overproducing mutant, such as for example a mutant deficient in the synthesis of the FUR regulator (Ferric uptake regulator) (Lemare et al., 2022).

According to one embodiment, step d) of the method is repeated at least once, preferably between 2 and 10 times, and more preferably between 4 and 8 times.

The present method will be described more precisely by means of the examples and figures below. Said examples are provided here by way of illustration and are not, unless otherwise indicated, intended to be limiting.

### LEGENDS OF THE FIGURES

FIG. 1: Diagram of the experimental protocol used for the preparation of the bacterial inoculum.

FIG. 2: Diagram of the treatment of the sample comprising lactic acid bacteria, whey, and the asbestos-containing product, after a bacterial growth cycle of 72 hours.

FIG. 3: Kinetics of extracting iron and magnesium from flock waste for 96 h in the presence of whey, with or without Lactobacillus plantarum added. The error bars are standard errors on the mean of 3 replicates.

FIG. 4: Extraction of iron and magnesium of flock waste after 72-hour cycles in the presence of whey with Lactobacillus plantarum added. The error bars are standard errors on the mean of 3 replicates.

FIG. 5: Kinetics of extracting iron and magnesium from fiber cement roofing tile waste for 96 h in the presence of whey, with or without Lactobacillus plantarum added. The error bars are standard errors on the mean of 3 replicates.

FIG. 6: Extraction of iron and magnesium from fiber cement roofing tile waste after 72-hour cycles in the presence of whey with Lactobacillus plantarum added. The error bars are standard errors on the mean of 3 replicates.

FIGS. 7A-7B: Percentage of iron and magnesium extracted in flock waste (FIG. 7A) and fiber cement roofing tile waste (FIG. 7B) ground after four 72-hour cycles in the presence of whey incubated in the presence of Lactobacillus plantarum.

FIGS. 8A-8C: Transmission electron microscopy (TEM-EDX) mapping of chrysotile fibers present in untreated (FIG. 8A) or altered asbestos cement waste after four 72-hour cycles in the presence of whey inoculated with Lactobacillus plantarum (FIG. 8B). Mg/Si Ratio of the different areas (entire area and areas 1, 2 and 3 (chosen to allow a better representation of the analyzed sample) of the sample) of the mapping (FIG. 8C).

FIG. 9: Growth curve for lactic acid bacteria (Lactobacillus pentosus (NCDO 363), Lactobacillus plantarum subsp argentoratensis (NCDO 365), Lactococcus lactis (DSM 16365T), Lactobacillus sakei subsp sakei 484 (ATCC 15521), Lactobacillus plantarum (ATCC 14917), Lactobacillus paraplantarum (CIP 104452), Lactobacillus salivarius (DSM 20555), Lactobacillus casei b135 (ATCC 334), Lactobacillus fermentum (DSM-20052), Pediococcus pentosaceus (ATCC 25744)) in whey medium under agitation at 30° C.

FIG. 10: Growth curve for 7 strains of lactic acid bacteria (Lactobacillus brevis (ATCC 20054), Lactococcus lactis 99, Lactobacillus rhamnosus (ATCC 7469), Pediococcus parvulus (ATCC19371), Lactobacillus paracasei (ATCC SD5275), Lactobacillus casei b69 (ATCC 393), Lactobacillus paracasei subsp paracasei (CIP 103918) in whey medium under agitation at 30° C.

FIG. 11: Growth curve for lactic acid bacteria (Lactobacillus pentosus (NCDO 363), Lactobacillus plantarum subsp argentoratensis (NCDO 365), Lactococcus lactis (DSM 16365T), Lactobacillus sakei subsp sakei 484 (ATCC 15521), Lactobacillus plantarum (ATCC 14917), Lactobacillus paraplantarum (CIP 104452), Lactobacillus salivarius (DSM 20555), Lactobacillus casei b135 (ATCC 334), Lactobacillus fermentum (DSM-20052), Pediococcus pentosaceus (ATCC 25744)) in a whey medium in unstirred condition at 30° C.

FIG. 12: Growth curve for 7 strains of lactic acid bacteria (Lactobacillus brevis (ATCC 20054), Lactococcus lactis 99, Lactobacillus rhamnosus (ATCC 7469), Pediococcus parvulus (ATCC19371), Lactobacillus paracasei (ATCC SD5275), Lactobacillus casei b69 (ATCC 393), Lactobacillus paracasei subsp paracasei (CIP 103918) in whey medium under agitation at 30° C.

FIG. 13: Cumulative quantity of iron extracted from chrysotile-gypsum (CHR-Gy) waste during six 72-hour treatment cycles in whey medium inoculated with various lactic acid bacteria. The iron present in the supernatant is presented by the dotted histogram and the iron present in the base by the hatched histogram.

FIG. 14: Cumulative quantity of magnesium extracted from chrysotile-gypsum (CHR-Gy) waste during six 72-hour treatment cycles in whey medium inoculated with various lactic acid bacteria. The supernatant is dashed and the pellet is hatched.

FIG. 15: Amount of iron extracted from chrysotile-gypsum waste (CHR-Gy) in the presence of whey medium seeded with Lactobacillus plantarum (four 72-hour cycles) followed by treatment with Pseudomonas putida KT2440, or the pyoverdine-overproducing mutant of Pseudomonas putida Dfur (five 24-hour cycles) or magnesium-free CAA medium (Control). Legend: white: treatment supernatant (whey+Lactobacillus plantarum); dotted line: bacterial alteration supernatant: WT/Δfur/CAA-Mg abiotic control, respectively; hatched line: bacterial pellets: WT/□fur, respectively

FIG. 16: Amount of magnesium extracted from chrysotile-gypsum waste (CHR-Gy) in the presence of whey medium seeded with Lactobacillus plantarum (four 72-hour cycles) followed by treatment with Pseudomonas putida KT2440, or the pyoverdine-overproducing mutant of Pseudomonas putida Dfur (five 24-hour cycles) or magnesium-free CAA medium (Control). Legend: white: treatment supernatant (whey+Lactobacillus plantarum); dotted line: bacterial alteration supernatant: WT/Δfur/CAA-Mg abiotic control, respectively; hatched line: bacterial pellets: WT/□fur, respectively.

### EXAMPLES

### I. Materials and Methods

### I.1. Asbestos Waste Preparation

For the implementation of the method, the following asbestos waste was used:
flock waste and fiber cement pipe waste: obtained from an asbestos removal worksite at Paris-Jussieu University and supplied by the company SOMEZ, and
fiber cement roofing tile waste: provided by the company CEFASC Environment.

The asbestos waste was ground (with the exception of flock waste) and sterilized. The grinding of the fiber cement samples was carried out for 10 min at 500 rpm in a Retsch PM 100 ball planetary mill (grinding carried out at Institut Charles Gerhart from Montpellier). Next, 0.2 g of asbestos sample: ground fiber cement or flock waste is taken. The samples were autoclaved for 20 min at 121° C. and then incubated for 14 days at 70° C. for sterilization.

### I.2. Preparation of Starting Bacterial Inoculum and Test Sample

Lactobacillus plantarum lactic acid bacteria (accession number in the Collection nationale des cultures de microorganismes (CNCM) no. ATCC 14917) and bovine whey (courtesy of Alsace Lait) were used.

First, lactic acid bacteria were cultured in MRS medium (Man, Rogosa, Sharpe agar) for 24 hours at 30° C. The bacterial culture was then centrifuged (5 min/9871 g) and washed twice in 5 ml whey. After washing, the pellet was resuspended in 10 ml of whey, then diluted 1:10 in whey to measure the optical density (OD) of the bacteria at a wavelength of 600 nm. After this measurement, the OD600 was adjusted to 1.

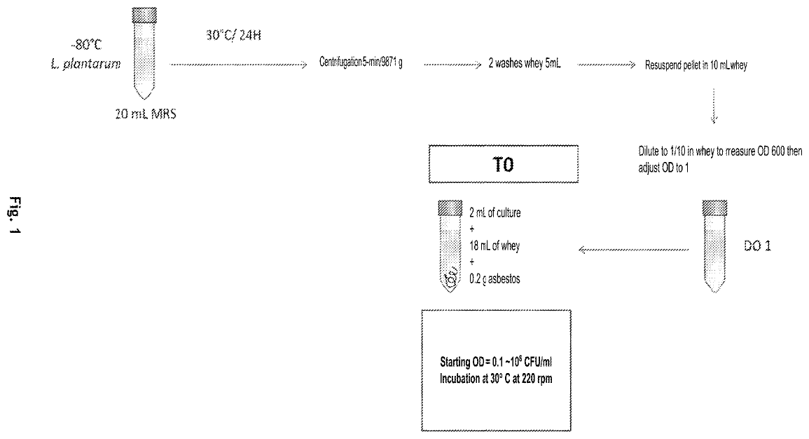

Once the bacterial culture was obtained, 2 ml thereof were mixed with 18 ml of whey and 0.2 g of asbestos. The concentration of the bacteria in this mixture is OD600 of 0.1 (or about 1×10⁸ CFU/ml). This mixture (including whey seeded with lactic acid bacteria+added whey and asbestos waste) is incubated at 30° C. with stirring (220 rpm). FIG. 1 illustrates the steps described above.

### I.3. Iron Assay

After 72 hours incubation (time required for the growth cycles of Lactobacillus plantarum lactic acid bacteria) of the mixture containing lactic acid bacteria, whey and asbestos waste, a colorimetric determination of iron was carried out on this mixture (sample). To this end, to a 20 μl sample (3 replicates per sample), 40 μL of saturated Na acetate (Sigma) (5.5 Molar) were added, then cold: 80 μL of bi-distilled water and 10 μL of thioglycolic acid diluted 10-fold in distilled water were added. The resulting mixture was then stirred and 10 μL of 0.5% bathophenantroline in bi-distilled water was added, followed by further stirring. The final mixture was left to stand overnight at 4° C., protected from light, and then transferred to a reading microplate. The reading was performed at 535 nm on a Tecan Infinite M200 microplate reader.

### I.4. Magnesium Assay

Just as for the iron assay, after 72 hours of incubation of the mixture containing the lactic acid bacteria, whey, and asbestos waste, a colorimetric assay of the magnesium was carried out from this mixture (sample).

To do so, to 3 μL of sample (3 replicates per sample) were added 300 μL of a mixture consisting of:
1 volume of reagent 1 (1 mol/L 2-methyl-2-Amino-1-Propanol and 215 μmol/L EGTA), and
1 volume of reagent 2 (300 μmol/L calmagite).

This mixture is left at rest for 30 seconds before depositing it on a reading microplate. The reading was performed at 500 nm on a Tecan Infinite M200 microplate reader.

### I.5. PH Measurement

In addition to iron and magnesium concentrations, the pH of samples containing lactic acid bacteria, asbestos waste and whey was measured after incubation for 72 hours, to determine whether bacterial metabolism maintains or even increases the acidity of the sample. The pH was measured with a pH-meter phenomenal® IS 2100L.

### I.6. Bacterial Growth Cycle and Asbestos Alteration

The inventors carried out several assays of iron and magnesium concentrations by repeating the bacterial growth cycles approximately 4 times. At each growth cycle, a dosage of the iron and magnesium was carried out and the pH of the sample was measured.

Before repeating a growth cycle, the whey obtained at the end of the incubation stage was centrifuged (30 min/9871 g). The entire supernatant is used for the iron and magnesium assay, and 40 ml whey is added to the remaining pellet, which undergoes further incubation (growth cycle). Before beginning the incubation step, the mixture was subjected to gentle centrifugation (5-min-67 g) in order to separate the asbestos and the lactic acid bacteria and thus release them for a new growth cycle. After centrifugation, 30 ml of the supernatant was collected and discarded, then 30 ml of whey was added to the rest of the mixture. This step of separating the bacteria from the asbestos was repeated once under the same centrifuging conditions. Next, 30 ml of the supernatant was again collected and discarded, and the remaining mixture was subjected to a new centrifugation step but faster and longer (30-min-9871 g) than the preceding centrifugation step. At the end of this centrifugation, the supernatant was completely removed and 20 ml of whey was added to obtain a mixture that was subjected to a new bacterial growth cycle.

After a 72-hour growth cycle, the organic acids produced during asbestos waste alteration were quantified by the AERIAL technology resource center using the Nuclear Magnetic Resonance (NMR) technique.

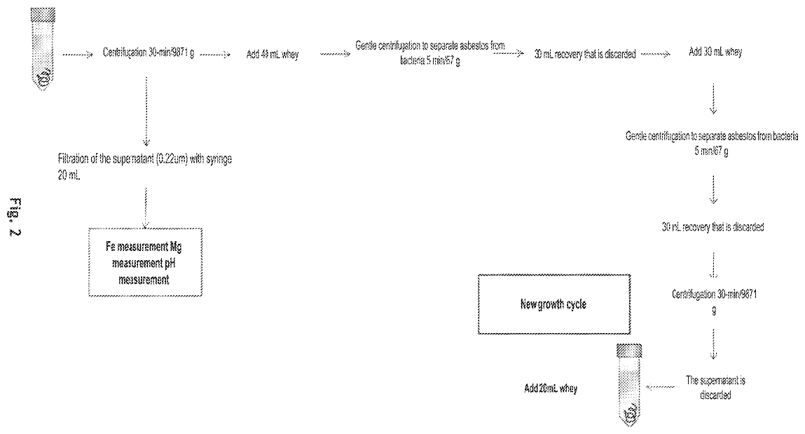

The treatment of the sample after one growth cycle is shown schematically in FIG. 2.

I.7. Kinetics of Asbestos Waste Alteration in the Presence of Whey with or without Addition of Lactic Acid Bacteria

The inventors followed the kinetics of asbestos waste alteration in the presence of whey, with Lactobacillus plantarum. To achieve this, the same operating procedure as shown in FIG. 1 was followed to obtain a sample comprising a mixture of whey, whey-inoculating bacteria, and asbestos waste.

A second sample containing only whey and asbestos waste was also prepared. 400 μl of each of these two samples were taken every 24, 48, 72 and 96 hours. The samples taken were then filtered with a Millex filter (0.22 μm) and iron and magnesium were assayed. The pH is measured at the end of the kinetics.

### II. Results

II.1. Alteration of Flock Waste with Whey Inoculated with Lactobacillus plantarum

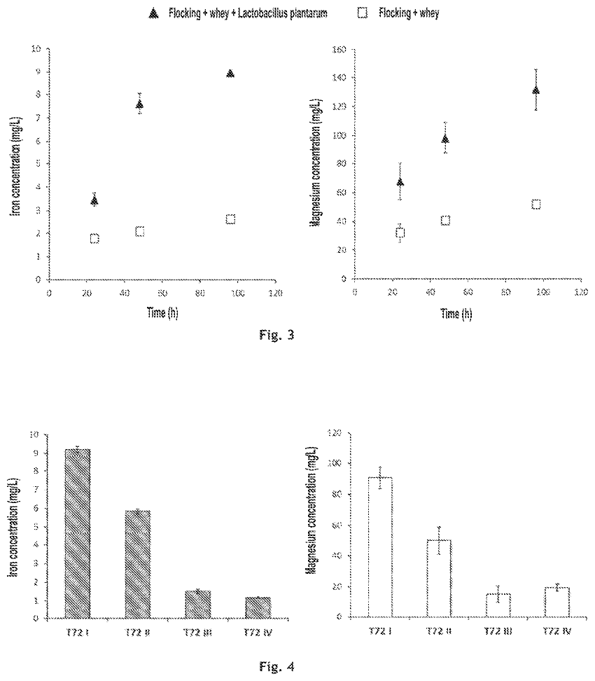

Extraction kinetics comparing the efficiency of alteration of flock waste in the presence of whey with or without L. plantarum was carried out (FIG. 3). The results show a strong increase in the extraction of iron and magnesium between 24 and 96 h in the presence of L. plantarum (3.48 to 8.93 mg/L for iron and 68 to 132 mg/L for magnesium) compared to the test without bacteria (1.78 to 2.64 mg/L for iron and 32 to 52 mg/L for magnesium). After 96 h of incubation in the presence of L. plantarum, the extraction of iron and magnesium is about three times greater than with the whey without bacteria. This high extraction measured during the kinetics is due to a strong decrease in the pH in the presence of L. plantarum (pH=3.85) whereas in the presence of whey without bacteria, the pH increases (pH=5.28).

The optimal duration of extraction of the whey in the presence of L. plantarum is about 96 h.

To confirm the efficacy of the whey-lactic acid bacterium mixture, the inventors carried out four cycles of bacterial growth of 72 h with renewal of the whey, in order to allow L. plantarum to develop in each cycle. The results of FIG. 4 show a high extraction of iron (9.22 to 1.17 mg/L) and magnesium (91 to 19 mg/L) which decreases from T72-1 to T72-4. The reduction in the dissolution is gradual during the alteration cycles in the presence of I. plantarum, linked to the acid pH and stable during the experiment, altering the asbestos fibers homogeneously and gradually. Table 1 below shows pH measurements after each growth cycle of Lactobacillus plantarum in whey in the presence or absence of asbestos-containing waste.

TABLE 1

| | | Fiber cement + | Flocking + whey + |
|---|---|---|---|
| | Whey + | whey + Lactobacillus | Lactobacillus |
| pH | Lactobacillus | plantarum | plantarum |
| T72H I | 3.58 | 3.86 | 3.69 |
| T72H II | 3.72 | 3.49 | 3.48 |
| T72H III | 4.02 | 3.72 | 3.68 |
| T72H IV | 4.03 | 3.80 | 3.75 |

Although the four cycles of bacterial growth carried out allow the extraction of large quantities of iron and magnesium, additional cycles can be carried out in order to obtain complete extraction of these elements and thus optimal alteration of the flock waste.

II.2. Alteration of Fiber Cement Roof Tile Waste by Whey Inoculated with Lactobacillus plantarum

The fiber cements were altered by whey in the presence of L. plantarum in order to verify whether the strong increase in pH could be compensated by adding this bacterium. This route was therefore tested on fiber cement roof tile samples composed of chrysotile fibers and a cement matrix.

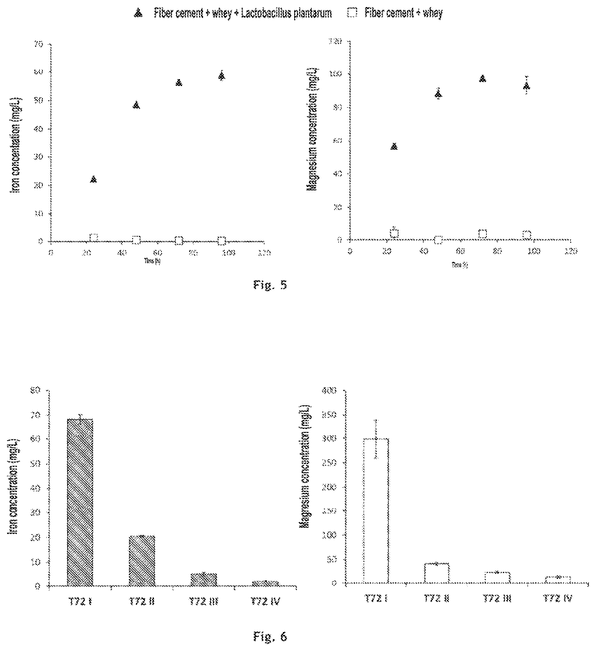

The inventors initially compared the extraction of the whey with or without L. plantarum (FIG. 5). After 96 hours of incubation, the presence of L. plantarum enabled 200 times more iron and 30 times more magnesium to be extracted than in the absence of bacteria. As before, this high extraction is due to a strong decrease in the pH in the presence of L. plantarum (pH=3.7) whereas in the presence of whey without bacteria, the pH increases (pH=5.7).

Between 24 and 96 h of incubation, the amount of iron and magnesium extracted increases in the presence of L. plantarum (22 to 59 mg/L for iron and 57 to 93 mg/L for magnesium) while in the presence of whey without bacteria the extraction tends to decrease (1.37 to 0.26 mg/L for iron and 4 to 3 mg/L for magnesium) over time. This reduction could be due to precipitation of the elements related to the increase in pH during the kinetics. From 72 h of incubation, a plateau is reached, indicating that the optimal extraction time is 72 h.

To determine the extraction limit of this pathway on asbestos cement roof tile waste, four 72-hour renewal cycles were carried out in the presence of whey and L. plantarum (FIG. 6). After the first 72-hour cycle, high extraction of iron (68 mg/L) and magnesium (299 mg/L) is observed. This extraction greatly falls during the cycles, reaching at T72-4 a concentration of 2.3 mg/L for iron and 14 mg/L for magnesium. The extraction of iron and magnesium drops sharply after the first cycle T72-1 for fiber cement. With flock waste, this extraction falls more gradually. The inventors concluded that this is due to the fact that the fiber cement waste was ground before the biological treatment. These results thus show the importance of grinding in the effectiveness of asbestos waste alteration.

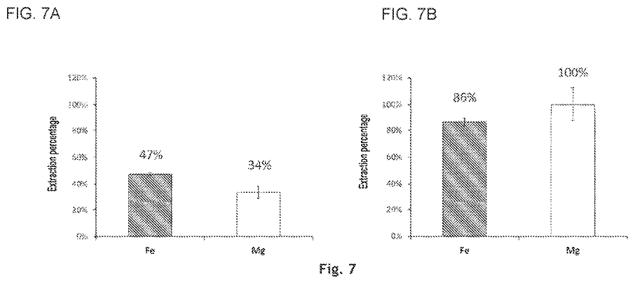

The results discussed above show that inoculation of whey with L. plantarum leads to a high extraction of iron and magnesium for both types of waste, flocking and fiber cement. After long-term alteration, very high extraction yields were obtained for fiber cement waste, with 86% iron and 100% magnesium extracted (FIGS. 7A-7B), which is extremely attractive given that fiber cement represents 80% of asbestos waste to be managed.

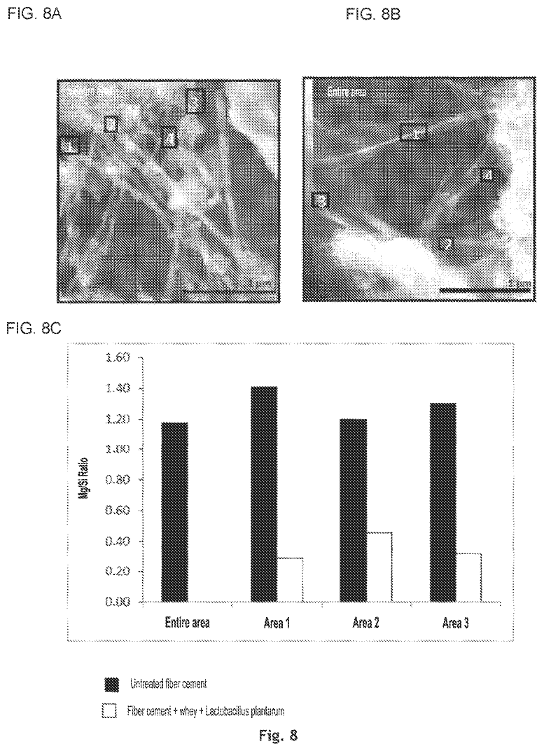

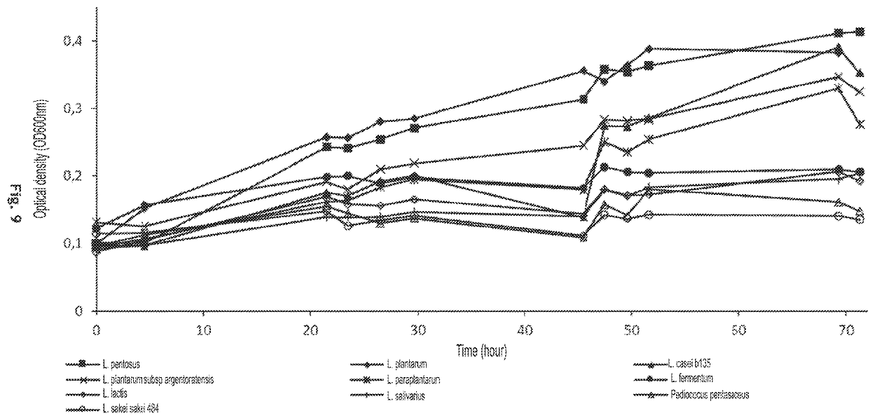

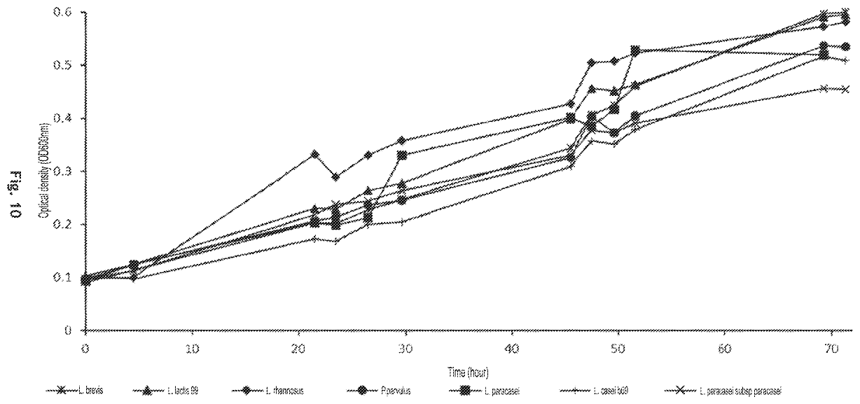

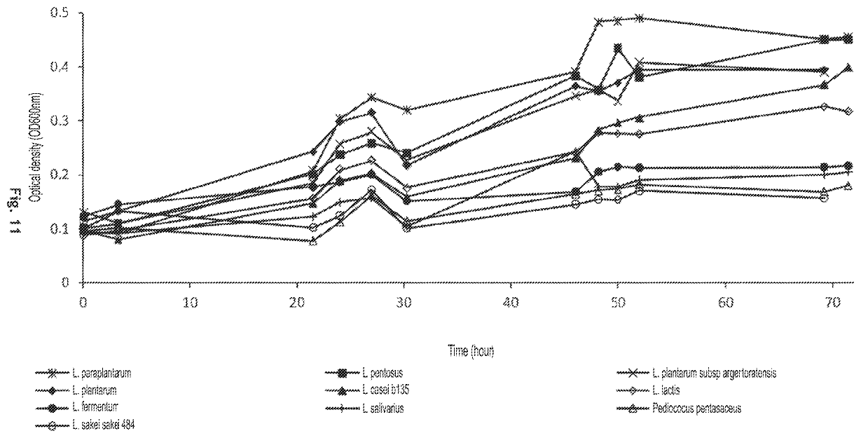

To validate the degradation, a mapping by transmission electron microscopy (TEM-EDX) on the altered fibers showed a magnesium/silica ratio of 0 to 0.5 whereas it is 1 to 1.5 in untreated fibers (FIGS. 8A-8C). This significant difference in the Mg/Si ratio is a vital parameter which attests to the dissolution of the elements present in the chrysotile fiber. Regarding flock waste, extraction yields of 47% for iron and 34% for magnesium were obtained, lower yields that could be improved by grinding these waste and/or continuing the alteration cycles.

II.3. Production of Organic Acids by Lactobacillus plantarum in the Presence of Asbestos Waste

The results presented above showed that the pH of the whey decreased and remained stable in the presence of L. plantarum and asbestos waste. The solutions after treatment were analyzed by the AERIAL technological resource center which used the Nuclear Magnetic Resonance (NMR) technique in order to determine and quantify the organic acids produced.

Organic acid production was tested under the following conditions: i) whey before treatment ii) whey in the presence of L. plantarum after 72 h of incubation iii) whey in the presence of L. plantarum with flock waste or fiber cement (roof tiles) after 72 h incubation. The results are presented in Table 2 below.

TABLE 2

| | Concentration (mM) | | | |
|---|---|---|---|---|
| | lactate | acetate | succinate | citrate |
| Whey | 85.5 | 4.9 | 0.72 | 10.7 |
| Whey + L. plantarum | 130 | 11.4 | 0.71 | 6.8 |
| Whey + L. plantarum + | 199.8 | 11.4 | 1.11 | n.d. |
| CHR-GY | | | | |
| Whey + L. plantarum + | 261.9 | 10.9 | 2.20 | n.d. |
| Fiber cem. | | | | |

n.d.: not determined; CHR-GY: chrysotile + gypsum; Fiber cem.: Fiber cement roof tile.

These results show that a greater concentration of lactate (130 mM) and acetate (11.4 mM) is found in the whey in the presence of L. plantarum, without asbestos, compared to the concentrations found in the whey before treatment (85.5 mM of lactate and 4.9 mM of acetate). In the presence of L. plantarum and asbestos, lactate, acetate but also succinate are found in greater quantity compared to whey alone. In the presence or absence of asbestos, the solutions have the same quantities of acetate (10.9 to 11.4 mM). However, the concentration of lactate and succinate is greater in the presence of asbestos with differences according to the type of waste. In the presence of flock waste, 199.8 mM of lactate and 1.11 mM of succinate are measured, while in the presence of fiber cement the concentrations are respectively 261.9 and 2.20 mM of lactate and succinate. The presence of asbestos therefore stimulates organic acid production by L. plantarum, but in different ways depending on the type of waste. This can be explained by the release of the magnesium present in this waste. Since more magnesium is released in the presence of fiber cement, organic acid production is stimulated to a greater extent than in the presence of flock waste.

### Test for Growth of Other Strains of Lactic Acid Bacteria

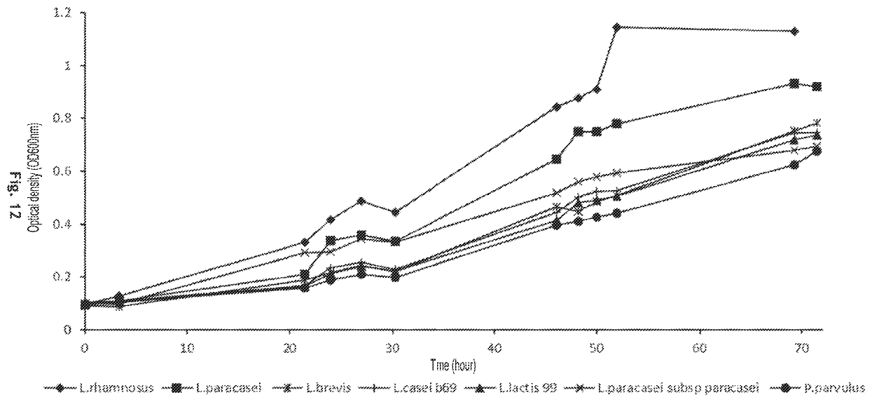

17 strains of lactic acid bacteria (Lactobacillus pentosus (NCDO 363), Lactobacillus plantarum subsp argentoratensis (NCDO 365), Lactococcus lactis (DSM 16365T), Lactobacillus sakei subsp sakei 484 (ATCC 15521), Lactobacillus plantarum (ATCC 14917), Lactobacillus paraplantarum (CIP 104452), Lactobacillus salivarius (DSM 20555), Lactobacillus casei b135 (ATCC 334), Lactobacillus fermentum (DSM-20052), Pediococcus pentosaceus (ATCC 25744), Lactobacillus brevis (ATCC 20054), Lactococcus lactis 99, Lactobacillus rhamnosus (ATCC 7469), Pediococcus parvulus (ATCC19371), Lactobacillus paracasei (ATCC SD5275), Lactobacillus casei b69 (ATCC 393) and Lactobacillus paracasei subsp paracasei (CIP 103918)) were grown in whey under agitation at 30° C. All showed growth capacity (FIG. 9). Of these 17 strains, seven (Lactobacillus brevis (ATCC 20054), Lactococcus lactis 99, Lactobacillus rhamnosus (ATCC 7469), Pediococcus parvulus (ATCC19371), Lactobacillus paracasei (ATCC SD5275), Lactobacillus casei b69 (ATCC 393), Lactobacillus paracasei subsp paracasei (CIP 103918)) show superior growth to the others with a final pH of 3.99 (FIG. 10).

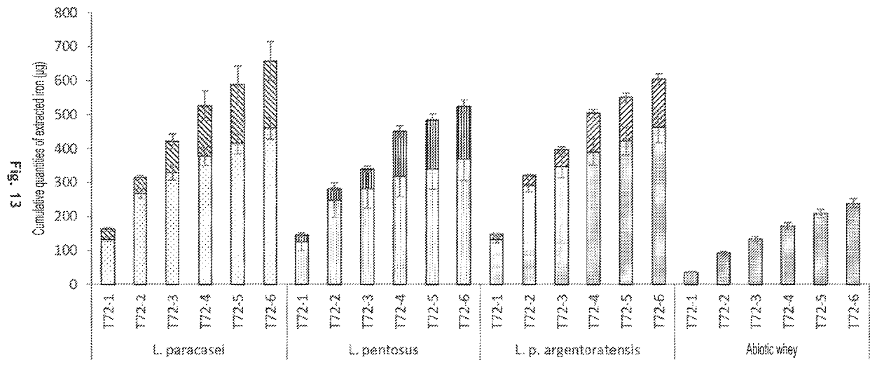

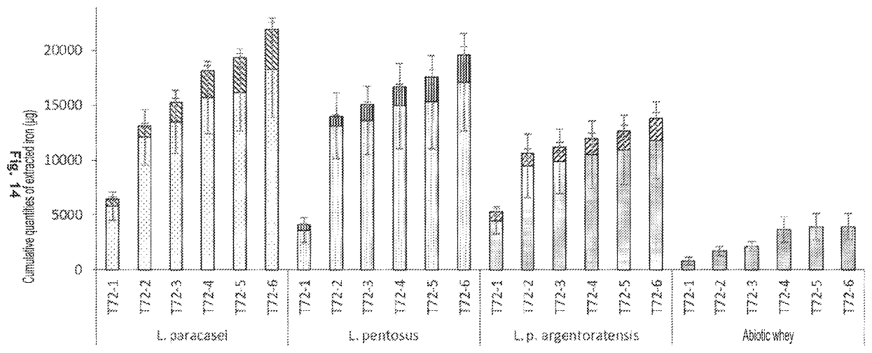

The same strains of lactic acid bacteria were cultivated at 30° C. but in the absence of agitation. FIGS. 11 and 12 show that the lactic acid bacteria tested exhibit better growth in a culture of whey in the absence of agitation.

Alteration of Chrysotile-Gypsum Waste by Lactobacillus paracasei, Lactobacillus Pentosus and Lactobacillus plantarum Subsp Argentoratensis

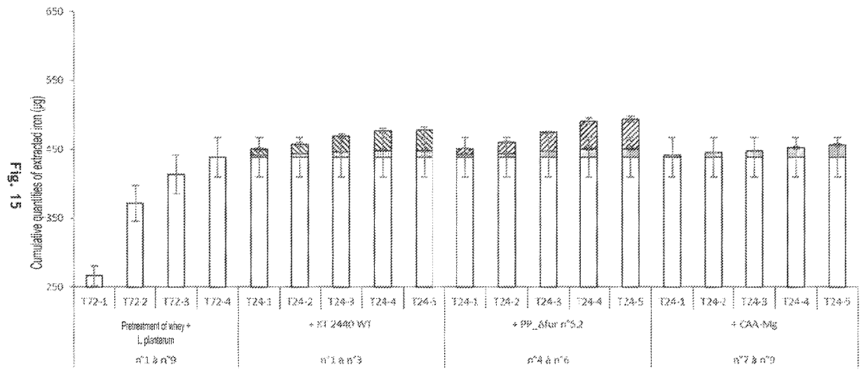

In order to verify the ability of these strains to degrade asbestos-containing waste, they were brought into contact with chrysotile-gypsum asbestos-containing waste for four 72-hour cycles under agitation at 30° C. Extracted iron and magnesium assays showed that these strains, like L. plantarum, are capable of altering these wastes (FIGS. 13 and 14). The amounts of iron extracted by these three strains are of the order of 50% of the iron present in the altered waste. However, as regards magnesium, the amounts extracted are about 100% alteration.

### Alteration of Chrysotile-Gypsum Waste by Pseudomonas

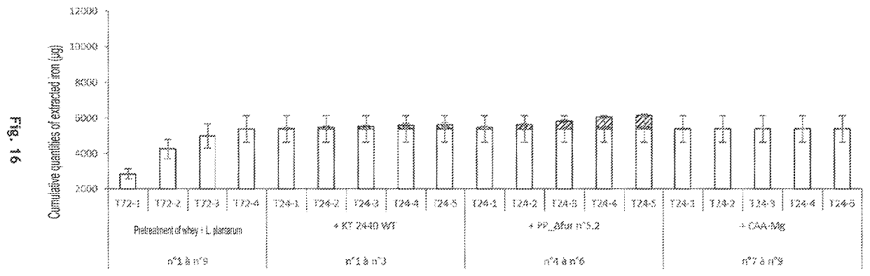

In samples treated with whey+L. plantarum, chrysotile gypsum was further altered by pyoverdine, a bacterial siderophore produced by Pseudomonas. A wild-type strain of Pseudomonas putida (KT2440 WT) and a pyoverdine-overproducing mutant (PPAfur) engineered and optimized by the inventors for continuous pyoverdine production were tested in parallel on chrysotile gypsum waste over five 24-hour cycles. This experiment was used to check whether the waste could be further degraded by bacterial alteration linked to the specific complexation of iron and bacterial growth using magnesium from alteration (FIGS. 15 and 16).

The treatment with the KT2440 WT strain made it possible to extract 1.7% of magnesium while the overproduction mutant has extracted 2 to 5% of magnesium from the waste already altered by the treatment with whey+L. plantarum.

These results show that biological alteration can continue after treatment with whey+lactic acid bacteria, confirming the active role of siderophores in iron complexation. In conclusion, experimental results presented below show that the method described herein actually makes it possible to alter the asbestos in a product containing it, in particular because the metabolic action of the lactic acid bacteria inoculating the whey makes it possible to maintain its acid pH throughout the alteration process, a process which is also facilitated by the grinding of the product comprising asbestos.

### BIBLIOGRAPHIC REFERENCES

Amouzou, K.-S., Prevost, H., and Divies, C. (1985) Influence de la supplémentation du lait en magnésium sur la fermentation lactique réalisée par S. lactis et S. thermophilus. Le Lait 65:21-34.
Damien, A. (2016) Guide du traitement des déchets-7e éd.: Réglementation et choix des procédés, Dunod.
Lemare, M., Puja, H., David, S. R., Mathieu, S., Ihiawakrim, D., Geoffroy, V. A., Rigouin, C. (2022) Engineering siderophore production in Pseudomonas to improve asbestos weathering. Microb Biotechnol 15 (9): 2351-2363.
Nelson, K. E., Weinel, C., Paulsen, I. T., Dodson, R. J., Hilbert, H., Martins dos Santos, V. A., Fouts, D. E., Gill, S. R., Pop, M., Holmes, M., Brinkac, L., Beanan, M., DeBoy, R. T., Daugherty, S., Kolonay, J., Madupu, R., Nelson, W., White, O., Peterson, J., Khouri, H., Hance, I., Chris Lee, P., Holtzapple, E., Scanlan, D., Tran, K., Moazzez, A., Utterback, T., Rizzo, M., Lee, K., Kosack, D., Moestl, D., Wedler, H., Lauber, J., Stjepandic, D., Hoheisel, J., Straetz, M., Heim, S., Kiewitz, C., Eisen, J., Timmis, K. N., Dusterhoft, A., Tummler, B., and Fraser, C. M. (2002) Complete genome sequence and comparative analysis of the metabolically versatile Pseudomonas putida KT2440. Environ. Microbiol. 4:799-808.
Spasiano, D., Luongo, V., Petreella, A., Alau, M., Pirozzi, F., Fratino, U., and Piccinni, A. F. (2017) Preliminary study on the adoption of dark fermentation as pretreatment for a sustainable hydrothermal denaturation of cement-asbestos composites. J Clean Prod 166:172-180.
Stanik et al (2006): “Destruction of the chrysotile asbestos structure with a population of bacteria Lactobacillus casei and Lactobacillus plantarum”, FEB, Volume 15-No 7, 2006. Weber, K. A., Achenbach, L. A., and Coates, J. D. (2006) Microorganisms pumping iron: anaerobic microbial iron oxidation and reduction. Nat Rev Microbiol 4:752.
Werner, A. J., Hochella, M. F., Guthrie, G. D., Hardy, J. A., Aust, A. E., and Rimstidt (1995) Asbestiform riebeckite (crocidolite) dissolution in the presence of Fe chelators: Implications for mineral-induced disease. Am Mineral 80:1093-1103.
EP2428254
WO2015/166359

1. A method for treating a product containing asbestos, characterized in that it comprises the following steps:
a) grinding the asbestos-containing product,
b) incubating the product ground in step a) with whey inoculated with lactic acid bacteria.

2. The method according to claim 1, characterized in that the grinding in step a) is carried out in a liquid medium, preferably in whey.

3. The method according to claim 1, characterized in that the method comprises, prior to step b), a step of seeding the whey with lactic acid bacteria.

4. The method according to claim 1, characterized in that the concentration of lactic acid bacteria in the whey containing the ground asbestos-containing product before incubation in step b) is between 1×10⁵ and 1×10⁹ CFU/ml, preferably between 1×10⁶ and 1×10⁸ CFU/ml and more preferably, is 1×10⁸ CFU/ml.

5. The method according to claim 1, characterized in that the pH of the whey containing the lactic acid bacteria and the ground asbestos-containing product in step b) is between 2.5 and 4.5, preferably between 3 and 4 and even more preferably, the pH is 3.7.

6. The method according to claim 1, characterized in that the incubation time in step b) is from 24 to 96 hours, preferably from 30 to 80 hours and more preferably, 72 hours.

7. The method according to claim 1, characterized in that step b) of the method is repeated at least once, preferably between 2 and 10 times, and more preferably between 4 and 6 times, said method optionally further comprising one or more steps of diluting the whey containing lactic acid bacteria and the ground asbestos-containing product.

8. The method according to claim 1, characterized in that it comprises a step c) of real-time assaying of the concentration of iron and/or magnesium released by the asbestos-containing product in the whey from step b).

9. The method according to claim 1, characterized in that the ground asbestos-containing product is an asbestos-containing waste preferably selected from the group consisting of flock or insulation waste or fiber cement, having a homogeneous or heterogeneous composition.

10. The method according to claim 1, characterized in that the lactic acid bacteria are bacteria with fermentative metabolism, in particular lactobacilli, lactococci or Pediococcus, preferably selected from Lactobacillus brevis, Lactococcus lactis, Pediococcus parvulus, Lactobacillus paracasei, Lactobacillus rhamnosus, Lactobacillus paracasei subsp paracasei, Lactobacillus pentosus, Lactobacillus casei and Lactobacillus plantarum.

11. The method according to claim 1, characterized in that it comprises a step d) of bringing an altered waste still containing iron and/or magnesium after incubation with whey seeded with lactic acid bacteria, into contact with a siderophore-producing bacterium.

12. The method according to claim 11, characterized in that the siderophore-producing bacterium is a bacterium from the group of fluorescent Pseudomonas capable of producing siderophores, preferably pyoverdine.

13. The method according to claim 12, characterized in that the fluorescent Pseudomonas are selected from: Pseudomonas lini, Pseudomonas putida, Pseudomonas monteilii, Pseudomonas syringae, Pseudomonas 20 aeruginosa PAO1, Pseudomonas fluorescens, Pseudomonas mosselii.

14. The method according to claim 13, characterized in that the fluorescent Pseudomonas is a strain of wild-type Pseudomonas putida (KT2440WT strain) or a pyoverdine-overproducing mutant.
